(19) United States
(12) Patent Application Publication
(10) Pub. No.: US 2026/0192805 A1
(43) Pub. Date: Jul. 9, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Toru KOKAKI, Tokyo (JP); Daichi Kato, Tokyo (JP); Takahiro Osawa, Tokyo (JP); Yuhei Shingai, Tokyo (JP)

(73) Assignee: HONDA MOTOR CO., LTD., Tokyo (JP)

(21) Appl. No.: 19/557,147

(22) Filed: Mar. 5, 2026

(30) Foreign Application Priority Data
Mar. 19, 2025 (JP) 2025-044888

(51) Int. Cl. B60W 30/182; B60W 50/14

(52) U.S. Cl. CPC B60W 30/182; B60W 50/14; B60W 2050/143; B60W 2050/146; B60W 2420/403; B60W 2420/408; B60W 2552/05; B60W 2556/20; B60W 2556/40

(57) ABSTRACT

A vehicle control device is capable of first control that performs traveling with a first stop position as a target position and that includes a transition from the first mode to the second mode, and second control that travels from a second stop position to a target position and that includes a transition from the second mode to the first mode, the first control is control that starts traveling by the first mode, switches a reference map from the first map to the second map, and transitions to the second mode at a point where a distance to the first stop position is equal to or less than a predetermined distance, and the second control is control that starts traveling by the second mode, switches the reference map from the second map to the first map, and transitions to the first mode at a predetermined point registered in advance.

### CROSS-REFERENCE TO RELATED APPLICATIONS

This application is based on and claims priority under 35 USC 119 from Japanese Patent Application No. 2025-044888 filed on March 19, 2025, the contents of which are incorporated herein by reference.

### TECHNICAL FIELD

The present disclosure relates to a vehicle control device, a vehicle control method, and a storage medium.

### BACKGROUND

In recent years, active efforts have been made to provide access to a sustainable transportation system in consideration of vulnerable people among traffic participants. In order to implement the above, focus has been placed on research and development on further improving safety and convenience of traffic by research and development related to autonomous driving techniques.

In the related art, in an autonomous driving system that causes a vehicle to travel autonomously without requiring a driving operation of a user, it is known that a route taken when a vehicle travels to a target position by a driving operation of a user is stored, and when the vehicle travels toward the same target position or on the same route, the vehicle is caused to travel based on a stored route history. In addition, it is known that route information on a route from a current position to the target position is generated based on information acquired by an in-vehicle sensor to cause the vehicle to travel.

For example, Japanese Patent Application Laid-Open Patent Publication No. 2023-63070 (hereinafter, referred to as Patent Literature 1) discloses a vehicle travel assist device that, in a case where it is determined that a vehicle will enter an intrusion prohibited area when moving along a target route, provides assist in correcting the target route in a stored route history so that the vehicle does not enter the intrusion prohibited area, and provides assist in moving the vehicle to a target stop position along the corrected target route and stopping the vehicle at the target stop position.

In a case where a vehicle is assisted to travel to a target position, for example, there may be general travel assistance of the vehicle performed when traveling on a general road, and specific region travel assistance in which travel assistance of the vehicle is performed using a user travel route when traveling to the target position by a driving operation of a user.

In this case, for example, when the vehicle travels from the general road to a specific region, or conversely, when the vehicle travels from the specific region to the general road, it is desirable to switch between the general travel assistance and the specific region travel assistance at an appropriate travel position. However, Patent Literature 1 does not disclose an appropriate switching position for travel assistance when traveling on a general road and a specific region.

An object of the present disclosure is to provide a vehicle control device, a vehicle control method, and a storage medium that are capable of performing smooth travel control by appropriate switching of travel assistance. This hence contributes to development of a sustainable transportation system.

### SUMMARY

A first aspect of the present disclosure relates to a vehicle control device capable of transitioning between a first travel mode and a second travel mode. The vehicle control device includes: one or more processors configured to perform travel control for moving, to a target position, a vehicle including an external environment recognition unit configured to perform external environment recognition; and a storage unit configured to store map information. The map information includes first map information and second map information, the first travel mode allows the vehicle to travel in a wider range than the second travel mode, the vehicle control device is capable of first travel control that performs traveling with a first stop position as a target position and that includes a transition from the first travel mode to the second travel mode, and second travel control that performs traveling from a second stop position to a target position and that includes a transition from the second travel mode to the first travel mode are possible, the first travel control is travel control that starts traveling by the first travel mode, switches a reference map from the first map information to the second map information, and transitions to the second travel mode at a point where a distance to the first stop position is equal to or less than a predetermined distance, and the second travel control is travel control that starts traveling by the second travel mode, switches the reference map from the second map information to the first map information, and transitions to the first travel mode at a predetermined point registered in advance.

A second aspect of the present disclosure relates to a vehicle control method performed by a vehicle control device. The vehicle control device includes one or more processors configured to perform travel control for moving, to a target position, a vehicle including an external environment recognition unit configured to perform external environment recognition, and a storage unit configured to store map information, the vehicle control device is configured to transition between a first travel mode and a second travel mode, the map information includes first map information and second map information, the first travel mode allows the vehicle to travel in a wider range than the second travel mode, the vehicle control method includes performing first travel control that performs traveling with a first stop position as a target position and includes a transition from the first travel mode to the second travel mode, and second travel control that performs traveling from a second stop position to a target position and includes a transition from the second travel mode to the first travel mode, the first travel control is travel control that starts traveling by the first travel mode, switches a reference map from the first map information to the second map information, and transitions to the second travel mode at a point where a distance to the first stop position is equal to or less than a predetermined distance, and the second travel control is travel control that starts traveling by the second travel mode, switches the reference map from the second map information to the first map information, and transitions to the first travel mode at a predetermined point registered in advance.

A third aspect of the present disclosure relates to a non-transitory computer-readable storage medium storing a vehicle control program for causing a vehicle control device to execute a process. The vehicle control device includes one or more processors configured to perform travel control for moving, to a target position, a vehicle including an external environment recognition unit configured to perform external environment recognition, and a storage unit configured to store map information, the vehicle control device is configured to transition between a first travel mode and a second travel mode, the map information includes first map information and second map information, the first travel mode allows the vehicle to travel in a wider range than the second travel mode, the process includes performing first travel control that performs traveling with a first stop position as a target position and includes a transition from the first travel mode to the second travel mode, and second travel control that performs traveling from a second stop position to a target position and includes a transition from the second travel mode to the first travel mode, the first travel control is travel control that starts traveling by the first travel mode, switches a reference map from the first map information to the second map information, and transitions to the second travel mode at a point where a distance to the first stop position is equal to or less than a predetermined distance, and the second travel control is travel control that starts traveling by the second travel mode, switches the reference map from the second map information to the first map information, and transitions to the first travel mode at a predetermined point registered in advance.

According to the present disclosure, it is possible to provide a vehicle control device, a vehicle control method, and a storage medium that are capable of performing smooth travel control by appropriate switching of travel assistance.

### BRIEF DESCRIPTION OF DRAWINGS

Exemplary embodiment(s) of the present invention will be described in detail based on the following figures, wherein:

FIG. 1 is a block diagram illustrating a configuration of a vehicle 1 equipped with a control device 100 of an embodiment.

FIG. 2 is a flowchart illustrating an example of memory processing for causing the vehicle 1 to enter a garage at home.

FIG. 3 is a diagram illustrating an example of a state in which the vehicle 1 travels from a destination to home during the memory processing for entering.

FIG. 4 is a flowchart illustrating an example of regeneration processing for causing the vehicle 1 to enter a garage 222 at home by private road travel assistance control.

FIG. 5 is a diagram illustrating an example of a state in which the vehicle 1 travels from the destination to home during the regeneration processing for entering.

FIG. 6 is a flowchart illustrating an example of memory processing for causing the vehicle 1 to leave the garage at home.

FIG. 7 is a diagram illustrating an example of a state of the vehicle 1 traveling from home to the destination during the memory processing for leaving.

FIG. 8 is a diagram illustrating an example of a notification screen to be displayed during the memory processing for leaving.

FIG. 9 is a flowchart illustrating an example of regeneration processing for causing the vehicle 1 to leave the garage 222 at home by the private road travel assistance control.

FIG. 10 is a diagram illustrating an example of a state in which the vehicle 1 travels from home to the destination during the regeneration processing for leaving.

### DESCRIPTION OF EMBODIMENTS

Hereinafter, an embodiment of a vehicle control device, a vehicle control method, and a storage medium of the present disclosure will be described with reference to the accompanying drawings.

Vehicle 1 Equipped with Control Device 100 according to Embodiment

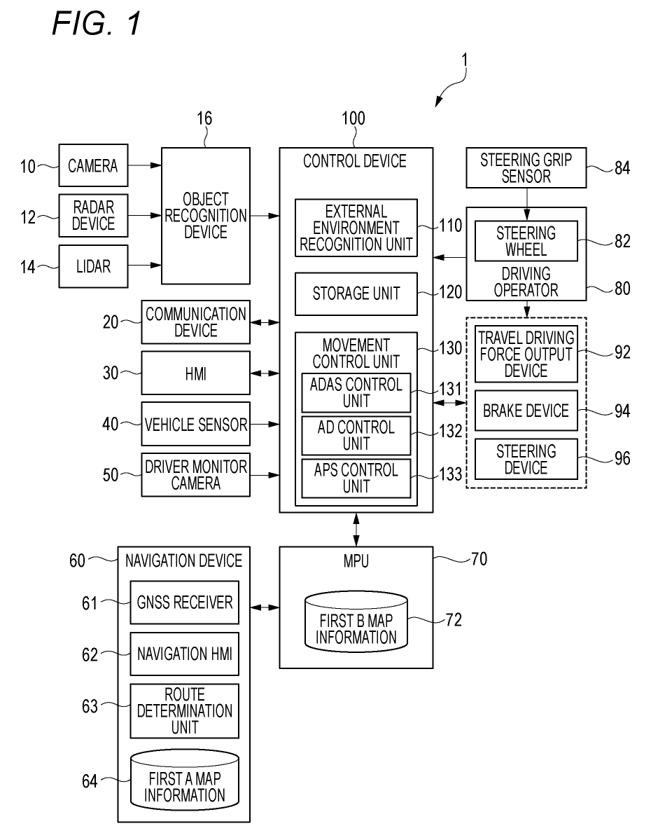

FIG. 1 is a block diagram illustrating a configuration of a vehicle 1 equipped with a control device 100 according to an embodiment. The control device 100 is an example of a "vehicle control device" of the present disclosure. The vehicle 1 is a vehicle that can execute so-called autonomous driving or assisted driving. The vehicle 1 is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by an electric generator connected to the internal combustion engine or electric power discharged from a secondary battery or a fuel cell.

The vehicle 1 includes a camera 10, a radar device 12, a light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, the control device 100, a travel driving force output device 92, a brake device 94, and a steering device 96. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached at any position on the vehicle 1.

The radar device 12 emits radio waves such as millimeter waves around the vehicle 1, and detects radio waves (reflected waves) reflected by an object to detect at least a position (distance and orientation) of the object. The radar device 12 is attached at any position on the vehicle 1.

The LIDAR 14 emits light (or an electromagnetic wave having a wavelength close to that of light) around the vehicle 1 and measures scattered light. The LIDAR 14 detects a distance to a target based on a time elapsed from light emission to light reception. The emitted light is, for example, pulsed laser light. The LIDAR 14 is attached at any position on the vehicle 1.

The object recognition device 16 performs sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present in the surroundings of the vehicle 1 or communicate with various server devices via a radio base station.

The HMI 30 presents various types of information to an occupant of the vehicle 1 and receives an input operation from the occupant. The HMI 30 includes various types of display devices, a speaker, a buzzer, a touch panel, a switch, a key, and the like.

The vehicle sensor 40 includes a vehicle speed sensor that detects a speed of the vehicle 1, an acceleration sensor that detects an acceleration, a yaw rate sensor that detects an angular velocity around a vertical axis, an azimuth sensor that detects an orientation of the vehicle 1, and the like.

The driver monitor camera 50 is, for example, a digital camera using a solid-state imaging device such as a CCD or a CMOS. The driver monitor camera 50 is attached at any position on the vehicle 1 in a position and an orientation in which a head of an occupant (hereinafter, also referred to as a "driver") seated in a driver's seat of the vehicle 1 is able to be imaged from the front (that is, in an orientation in which a face is imaged).

The navigation device 60 includes, for example, a global navigation satellite system (GNSS) receiver 61, a navigation HMI 62, and a route determination unit 63. The navigation device 60 stores first A map information 64 in a storage device such as a hard disk drive (HDD) or a flash memory. The first A map information 64 is, for example, a navigation map (standard map (SD map)). The first A map information 64 is an example of "first map information" of the present disclosure.

The GNSS receiver 61 specifies a position of the vehicle 1 based on a signal received from a GNSS satellite. The position of the vehicle 1 may be specified or complemented by an inertial navigation system (INS) using an output of the vehicle sensor 40.

The navigation HMI 62 includes a display device, a speaker, a touch panel, a key, and the like. The navigation HMI 62 may be made common to the HMI 30 partially or entirely.

For example, with reference to the first A map information 64, the route determination unit 63 determines a route (hereinafter, also referred to as an "on-map route") from the position of the vehicle 1 specified by the GNSS receiver 61 (or any position that is received) to a destination input by the occupant using the navigation HMI 62. The first A map information 64 is, for example, information in which a road shape is expressed by a link indicating a road and nodes connected by the link. The first A map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 stores first B map information 72 in a storage device such as an HDD or a flash memory. The first B map information 72 is map information with higher accuracy than the first A map information 64. The first B map information 72 is, for example, a high-definition map (HD map). The first B map information 72 includes, for example, information on a center of a lane or information on a boundary of the lane. The first B map information 72 may include road information, traffic regulation information, address information, facility information, telephone number information, and the like. The first B map information 72 may be updated, as required, by the communication device 20 communicating with another device. The first B map information 72 is an example of the "first map information" of the present disclosure.

The driving operator 80 includes, for example, an accelerator pedal, a brake pedal, a shift lever, and other operators in addition to a steering wheel 82 (an example of a steering device). A sensor that detects an operation amount or presence or absence of an operation is attached to the driving operator 80, and a detection result thereof is output to some or all of the control device 100, the travel driving force output device 92, the brake device 94, and the steering device 96. The steering wheel 82 is not necessarily in an annular shape, and may be in a form of irregular steering, joy stick, a button, or the like.

A steering grip sensor 84 is attached to the steering wheel 82. The steering grip sensor 84 is implemented by a capacitance sensor or the like, and outputs, to the control device 100, a signal capable of detecting whether the driver is gripping the steering wheel 82.

The control device 100 includes an external environment recognition unit 110, a storage unit 120, and a movement control unit 130.

The external environment recognition unit 110 acquires, from the object recognition device 16, external environment information for recognizing an external environment of the vehicle 1 that is acquired by the camera 10, the radar device 12, and the LIDAR 14. The external environment recognition unit 110 performs external environment recognition based on the acquired external environment information (spatial information).

The storage unit 120 stores a program for the movement control unit 130 to control each unit. The storage unit 120 stores second map information based on the external environment information obtained by the external environment recognition unit 110. The storage unit 120 stores the second map information based on the external environment information obtained by the external environment recognition unit 110 during past traveling of the vehicle 1. The storage unit 120 stores the second map information in which a route during the past traveling of the vehicle 1 is associated with map information based on the external environment information obtained by the external environment recognition unit 110 during the past traveling. The second map information is, for example, a simultaneous localization and mapping (SLAM) map. The second map information includes environment information based on the external environment recognition.

The movement control unit 130 performs travel control for moving the vehicle 1 to a target position. The movement control unit 130 includes an ADAS control unit 131, an AD control unit 132, and an APS control unit 133. The ADAS control unit 131 is implemented by an advanced driver assistance systems electronic control unit (ADAS_ECU). The AD control unit 132 is implemented by an automatic driving electronic control unit (AD_ECU). Similarly to the AD control unit 132, the APS control unit 133 is implemented by an AD_ECU. However, the APS control unit 133 may be implemented by, for example, an automatic parking systems electronic control unit (APS_ECU), which is a separate circuit from the AD control unit 132. The movement control unit 130 (the ADAS control unit 131, the AD control unit 132, and the APS control unit 133) is an example of a "processor" of the present disclosure.

Each of the ADAS_ECU, the AD_ECU, and the APS_ECU is implemented by, for example, a hardware processor such as a central processing unit (CPU) executing a program (software). Some or all of these components may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

The movement control unit 130 can perform travel control of the vehicle 1 by general road travel assistance control and travel control of the vehicle 1 by private road travel assistance control. The general road travel assistance control is, for example, a travel mode of assisted driving applied to traveling of the vehicle 1 on a general road and a highway. The general road travel assistance control is a mode for traveling mainly using the first A map information 64 or the first B map information 72, and is, for example, autonomous traveling by the AD control unit 132. The private road travel assistance control is, for example, a travel mode of the assisted driving applied to traveling of the vehicle 1 on a private land (including a private road). The private road travel assistance control is a mode for traveling mainly using the second map information, and is, for example, autonomous traveling by the APS control unit 133. The second map information includes not only travel information on a private land (private road) but also travel information on a general road in a certain region. The general road travel assistance control is a mode that allows traveling in a wider range than the private road travel assistance control. The movement control unit 130 can transition the travel control of the vehicle 1 between the general road travel assistance control and the private road travel assistance control. The general road travel assistance control is an example of a "first travel mode" of the present disclosure. The private road travel assistance control is an example of a "second travel mode" of the present disclosure.

The movement control unit 130 can perform entering control that performs traveling with, for example, a garage at home as a target position and includes a transition from the general road travel assistance control to the private road travel assistance control, and leaving control that performs traveling from, for example, the garage at home to a target position and includes a transition from the private road travel assistance control to the general road travel assistance control. the garage at home is an example of a "first stop position" and a "second stop position" of the present disclosure. The entering control is an example of "first travel control" of the present disclosure. The leaving control is an example of "second travel control" of the present disclosure.

In the entering control, the movement control unit 130 starts traveling by the general road travel assistance control, switches a reference map from the first map information (navigation map, high-definition map) to the second map information (SLAM map), and transitions to the private road travel assistance control at a point where a distance to the garage at home is equal to or less than a predetermined distance. In the leaving control, the movement control unit 130 starts traveling by the private road travel assistance control, switches the reference map from the second map information to the first map information, and transitions to the general road travel assistance control at a predetermined point registered in advance. The "predetermined point" is, for example, a boundary point between a private road and a general road.

In the entering control, the movement control unit 130 switches the reference map from the first map information to the second map information during the traveling on the general road. In a case of the entering control, the movement control unit 130 switches the reference map to the second map information at a matching establishment point of the second map information (SLAM map). When matching of the second map information is established before entering the private road, the movement control unit 130 performs the entering control with reference to the second map information. The matching means that a degree of coincidence between a feature obtained from the external environment information and a feature of the second map information stored in the storage unit 120 is equal to or greater than a threshold value, making it possible to estimate a self-position.

In the leaving control, the movement control unit 130 sets the second map information as the reference map from the garage at home, and switches the reference map from the second map information to the first map information during the traveling on the general road. In a case of the leaving control, the reference map is switched to the first map information at a matching end point of the second map information. The movement control unit 130 performs the leaving control with reference to the second map information until a point where the matching of the second map information ends even when the transition is performed from the private road to the general road.

When the second map information used in the leaving control is generated, the movement control unit 130 issues a notification prompting the driver of the vehicle 1 to stop at a switching position from the private road to the general road, and registers a position where the vehicle 1 stops in response to the notification as the predetermined point. The "switching position" is a position immediately before leaving from the private road to the general road. The predetermined point is a point where the travel mode of the vehicle 1 is transitioned from the private road travel assistance control to the general road travel assistance control. Since the vehicle 1 temporarily stops at the predetermined point at the time of generation (at the time of memory) of the second map information, the vehicle 1 also temporarily stops at the predetermined point at the time of reproduction.

In the leaving control, the movement control unit 130 sets control accuracy of travel control based on the second map information from the garage at home to the first point at a predetermined distance higher than control accuracy of travel control based on the second map information from the first point. The first point is, for example, a boundary position between a private road region close to a garage and a private road region far from the garage on a private road at home. The private road region close to the garage is, for example, a region from inside the garage to outside the garage. The private road region far from the garage is, for example, a region extending linearly on the private road slightly away from the garage. The movement control unit 130 accurately performs the leaving control of the vehicle 1 when the vehicle 1 is moved from inside of the garage to outside of the garage by, for example, increasing a control matching rate between the acquired information and the map information.

In the entering control, the movement control unit 130 sets control accuracy of travel control based on the second map information to the second point where a distance to the garage at home is a predetermined distance higher than control accuracy of travel control based on the second map information from the second point. The "second point" is, for example, a point of 10 m remaining to the garage. That is, the "second point" is a point where the travel control using the second map information (SLAM map) by the AD control unit 132 is transitioned to the travel control using the second map information (SLAM map) by the APS control unit 133. The "second point" is not limited to the point of 10 m remaining to the garage, and may be, for example, a point of 9 m or 11 m remaining to the garage.

The travel driving force output device 92 outputs, to driving wheels, a travel driving force (torque) for the vehicle to travel. The travel driving force output device 92 includes, for example, a combination of an internal combustion engine, an electric motor, a transmission, and the like, and an electronic control unit (ECU) that controls the combination. The ECU controls the above configuration according to information received from the movement control unit 130 or information received from the driving operator 80.

The brake device 94 includes, for example, a brake caliper, a cylinder that transmits a hydraulic pressure to the brake caliper, an electric motor that generates the hydraulic pressure in the cylinder, and a brake ECU. The brake ECU controls the electric motor according to the information received from the movement control unit 130 or the information received from the driving operator 80, and outputs a braking torque to each wheel according to a braking operation.

The steering device 96 includes, for example, a steering ECU and an electric motor. The electric motor changes an orientation of a steered wheel, for example, by applying a force to a rack-and-pinion mechanism. The steering ECU drives the electric motor according to the information received from the movement control unit 130 or the information received from the driving operator 80 to change the orientation of the steered wheel.

Entering control of Vehicle 1

### Memory Processing for Entering

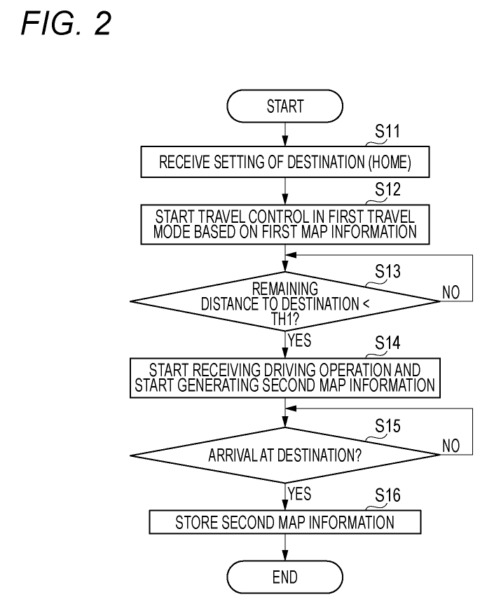

FIG. 2 is a flowchart illustrating an example of memory processing for causing the vehicle 1 to enter the garage at home. This is a situation in which a user who gets on the vehicle 1 returns home from a destination and intends to cause the vehicle 1 to enter the garage at home. However, the second map information (SLAM map) in which route information of the vehicle 1 when the vehicle 1 enters the garage at home is associated with the map information based on the external environment information obtained by the external environment recognition unit 110 is not yet stored in the storage unit 120. Therefore, this is a situation in which the vehicle 1 cannot enter the garage at home by the private road travel assistance control. Therefore, the user attempts to store the second map information for causing the vehicle 1 to enter the garage by the private road travel assistance control. The user operates, for example, the navigation HMI 62 of the navigation device 60 to perform navigation setting in which the destination of the vehicle 1 is the garage at home, and performs the memory processing for entering.

The control device 100 receives the navigation setting from the user with the destination being the garage at home (step S11).

The control device 100 starts the travel control in the first travel mode (general road travel assistance control) based on the first map information (navigation map, high-definition map) (step S12). At this time, the control device 100 issues a notification, for example, "GENERAL ROAD AUTONOMOUS TRAVELING IS BEING PERFORMED" by characters, a voice, an indicator, or the like via the navigation HMI 62.

Next, the control device 100 determines whether a remaining distance from the vehicle 1 to the destination is less than TH1 (step S13). TH1 is, for example, 88 [m]. When it is determined in step S13 that the remaining distance from the vehicle 1 to the destination is not less than TH1 (step S13: No), the control device 100 repeats processing of step S13.

When it is determined in step S13 that the remaining distance from the vehicle 1 to the destination is less than TH1 (step S13: Yes), the control device 100 starts receiving a manual driving operation of the user and starts generating the second map information in which the route information of the vehicle 1 acquired by the driving operation is associated with the map information based on the external environment information (step S14). At this time, the control device 100 issues a notification, for example, "MAP INFORMATION FOR AUTONOMOUS ENTERING IS STORED. PLEASE PERFORM MANUAL DRIVING" by characters, a voice, an indicator, or the like via the navigation HMI 62.

The control device 100 determines whether the vehicle arrives at the garage at home as the destination (step S15). When it is determined in step S15 that the vehicle does not arrive at the destination (step S15: No), the control device 100 repeats processing of step S15.

When it is determined in step S15 that the vehicle arrives at the destination (step S15: Yes), the control device 100 stores the generated second map information in the storage unit 120 (step S16), and ends the memory processing for entering.

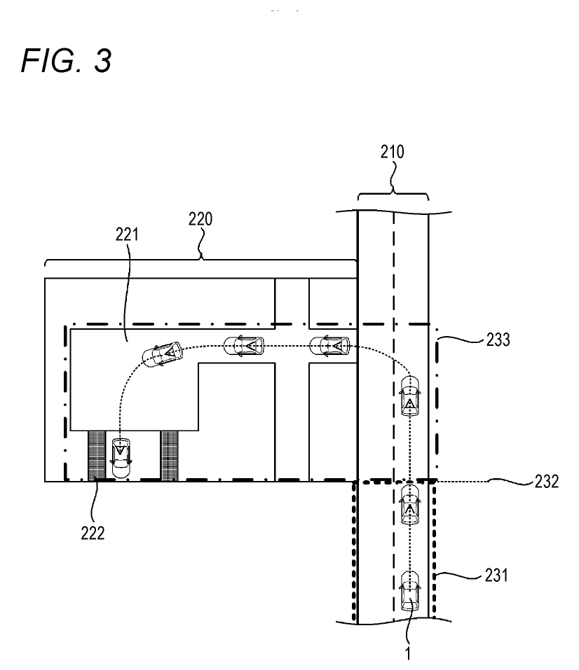

FIG. 3 is a diagram illustrating an example of a state in which the vehicle 1 travels from the destination to home during the memory processing for entering. The user of the vehicle 1 travels on a general road 210 from a destination, enters a private road 221 of a private land 220, and intends to cause the vehicle 1 to enter a garage 222 in the private land 220.

In FIG. 3, it is assumed that the navigation setting of the memory processing for causing the vehicle 1 to enter the garage at home is performed in a section 231 (within a broken line) which is a position slightly before the vehicle 1 arrives at the home, for example. The vehicle 1 performs the travel control in the general road travel assistance control (first travel mode) based on the navigation map and the high-definition map (first map information) on the general road 210 in the section 231.

When it is determined that the vehicle 1 reaches a point 232 at a remaining distance of 88 [m] to the garage 222 at home, the vehicle 1 stops the general road autonomous traveling by the general road travel assistance control of the vehicle 1 and switches to traveling by manual driving of the user. In FIG. 3, when the vehicle 1 reaches a section 233 (within a one-dot chain line) in which the remaining distance to the garage 222 is less than 88 [m], the vehicle 1 starts generating the SLAM map (second map information) in which the route information of the vehicle 1 acquired by the manual driving of the user is associated with the map information based on the external environment information. The section 233 includes not only the private road 221 leading to the garage 222 in the private land 220 but also a part of the general road 210 connected the private road 221. When the vehicle 1 enters the garage 222, the vehicle 1 stores the SLAM map generated by the manual driving in the section 233 in the storage unit 120.

### Regeneration Processing for Entering

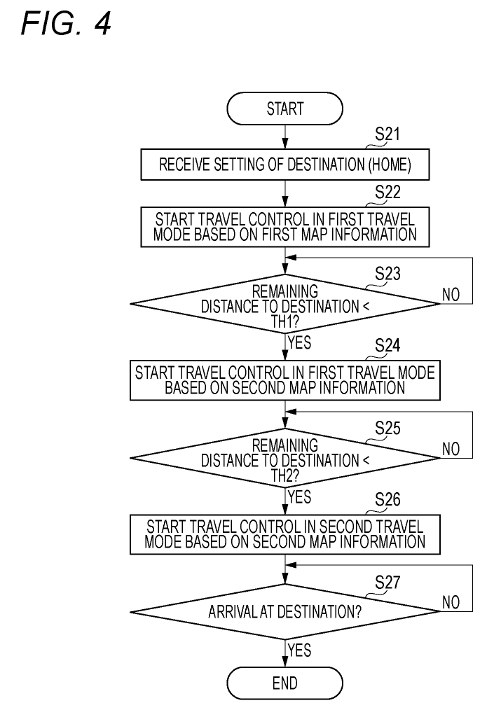

FIG. 4 is a flowchart illustrating an example of regeneration processing for causing the vehicle 1 to enter the garage 222 at home by the private road travel assistance control. The user who gets on the vehicle 1 returns home from the destination and intends to cause the vehicle 1 to enter the garage 222 at home. However, this example is a situation in which the memory processing for entering described in FIG. 2 and 3 is already completed, and the second map information (SLAM map) is stored in the storage unit 120. The vehicle 1 can perform the regeneration processing for causing the vehicle 1 to enter the garage 222 by the private road travel assistance control based on the second map information. The user operates, for example, the navigation HMI 62 of the navigation device 60 to perform the navigation setting in which the destination of the vehicle 1 is the garage 222 at home, and performs the regeneration processing for entering.

The control device 100 receives the navigation setting from the user with the destination being the garage 222 at home (step S21).

The control device 100 starts the travel control in the first travel mode (general road travel assistance control) based on the first map information (navigation map, high-definition map) (step S22). At this time, the control device 100 issues the notification, for example, "GENERAL ROAD AUTONOMOUS TRAVELING IS BEING PERFORMED" by the characters, the voice, the indicator, or the like via the navigation HMI 62.

Next, the control device 100 determines whether the remaining distance from the vehicle 1 to the destination (garage 222) is less than TH1 (step S23). TH1 is, for example, 88 [m]. When it is determined in step S23 that the remaining distance from the vehicle 1 to the destination is not less than TH1 (step S23: No), the control device 100 repeats processing of step S23.

When it is determined in step S23 that the remaining distance from the vehicle 1 to the destination is less than TH1 (step S23: Yes), the control device 100 starts the travel control in the first travel mode (general road travel assistance control) based on the second map information (SLAM map) stored in the storage unit 120 (step S24).

The control device 100 determines whether the remaining distance from the vehicle 1 to the destination is less than TH2 (step S25). TH2 is, for example, 10 [m]. When it is determined in step S25 that the remaining distance from the vehicle 1 to the destination is not less than TH2 (step S25: No), the control device 100 repeats processing of step S25.

When it is determined in step S25 that the remaining distance from the vehicle 1 to the destination is less than TH2 (step S25: Yes), the control device 100 starts the travel control in the second travel mode (private road travel assistance control) based on the second map information (SLAM map) stored in the storage unit 120 (step S26). At this time, the control device 100 issues a notification, for example, "AUTONOMOUS PARKING IS BEING PERFORMED" by characters, a voice, an indicator, or the like via the navigation HMI 62.

The control device 100 determines whether the vehicle arrives at the garage 222 at home as the destination (step S27). When it is determined in step S27 that the vehicle does not arrive at the destination (step S27: No), the control device 100 repeats processing of step S27. When it is determined in step S27 that the vehicle arrives at the destination (step S27: Yes), the control device 100 ends the regeneration processing for entering.

Although it is determined in step S23 whether the remaining distance to the destination is less than TH1 (88 [m]), the present disclosure is not limited thereto. For example, it may be determined whether matching with the second map information stored in the storage unit 120 is established, and the travel control in the first travel mode based on the second map information may be started when the matching is established.

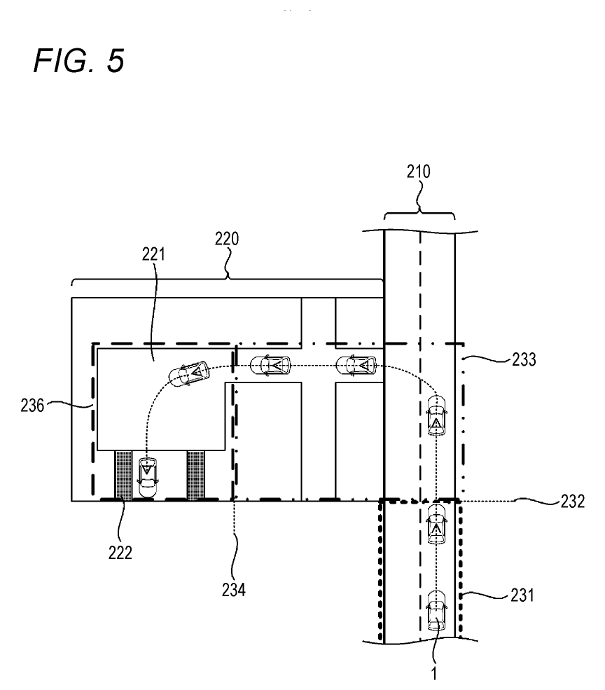

FIG. 5 is a diagram illustrating an example of a state in which the vehicle 1 travels from the destination to home during the regeneration processing for entering. The user is in the middle of returning home from the destination by autonomous traveling of the vehicle 1. The user performs the navigation setting with the destination of the vehicle 1 being the garage 222 at home.

The vehicle 1 determines whether the vehicle 1 reaches the point 232 of the remaining distance of 88 [m] to the garage 222 at home, and when it is determined that the vehicle 1 does not reach the point 232, the vehicle 1 performs the travel control in the general road travel assistance control (first travel mode) based on the navigation map and the high-definition map (first map information) on the general road 210 in the section 231 (within the broken line) where the vehicle 1 does not reach the point 232 yet, for example.

When it is determined that the vehicle 1 reaches the point 232 at the remaining distance of 88 [m], the vehicle 1 stops the general road travel assistance control based on the navigation map and the high-definition map, and transitions the travel control to the general road travel assistance control based on the SLAM map (second map information) stored in the memory processing for entering. While traveling on the general road 210, the vehicle 1 switches a map to be referred to from the navigation map and the high-definition map to the SLAM map while performing the travel control of the general road travel assistance control.

The vehicle 1 performs the travel control of the general road travel assistance control based on the SLAM map in a section 235 (within a two-dot chain line) that is a range from the point 232 at the remaining distance of 88 [m] to the garage 222 to, for example, a point 234 at a remaining distance of 10 [m] to the garage 222. The section 235 includes not only the general road 210 but also a part of the private road 221 in the private land 220 connected to the general road 210.

When it is determined that the vehicle 1 reaches the point 234 at the remaining distance of 10 [m] to the garage 222 at home, the vehicle 1 stops the general road travel assistance control based on the SLAM map and transitions the travel control to the private road travel assistance control (second travel mode) based on the SLAM map. When the vehicle 1 travels in a section 236 (within a broken line) which is a region close to the garage 222 (remaining distance of less than 10 [m]) in the private land 220, control accuracy of the travel control based on the SLAM map is increased by transitioning from the general road travel assistance control to the private road travel assistance control.

In this example, a position where the remaining distance to the destination is 88 [m] is set as the point 232, but the present disclosure is not limited thereto. For example, the point 232 may be a position where the matching with the SLAM map is established.

### Leaving Control of Vehicle 1

### Memory Processing for Leaving

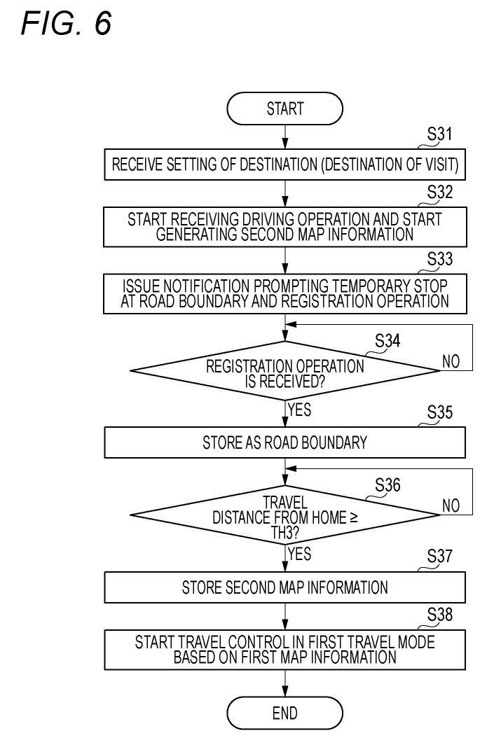

FIG. 6 is a flowchart illustrating an example of memory processing for causing the vehicle 1 to leave the garage at home. This is a situation in which the user who gets on the vehicle 1 causes the vehicle 1 to leave the garage at home and is going out. However, the second map information (SLAM map) in which route information of the vehicle 1 when the vehicle 1 leaves the garage at home is associated with the map information based on the external environment information obtained by the external environment recognition unit 110 is not yet stored in the storage unit 120. Therefore, this is a situation in which the vehicle 1 cannot leave the garage at home by the private road travel assistance control and go out. Therefore, the user attempts to store the second map information for causing the vehicle 1 to leave the garage by the private road travel assistance control. The user operates, for example, the navigation HMI 62 of the navigation device 60 to perform navigation setting in which the destination of the vehicle 1 is a destination of visit, and performs memory processing for leaving.

The control device 100 receives the navigation setting from the user with the destination being the destination of visit (step S31).

The control device 100 starts receiving a manual driving operation of the user and starts generating the second map information in which the route information of the vehicle 1 acquired by the driving operation is associated with the map information based on the external environment information (step S32). At this time, the control device 100 issues a notification, for example, "MAP INFORMATION FOR AUTONOMOUS LEAVING IS STORED. PLEASE PERFORM MANUAL DRIVING" by characters, a voice, an indicator, or the like via the navigation HMI 62.

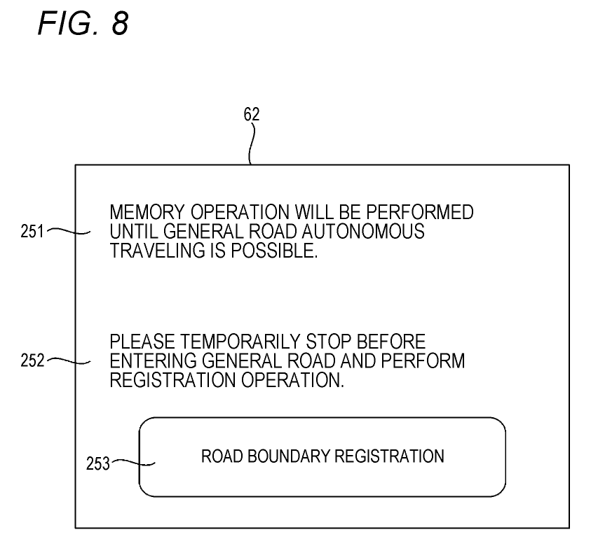

Next, at the time of leaving the private road in the private land to enter the general road outside the private land, the control device 100 issues a notification prompting a temporary stop at a road boundary between the private road and the general road and a registration operation of storing the temporary stop position (step S33). A specific example of this notification will be described later with reference to FIG. 8.

The control device 100 determines whether a registration operation from the user in response to the notification in step S33 is received (step S34). When the registration operation is not received in step S34 (step S34: No), the control device 100 repeats processing of step S34.

When the registration operation is received in step S34 (step S34: Yes), the control device 100 stores a position where the user temporarily stops the vehicle 1 in the storage unit 120 as the road boundary (step S35).

Next, the control device 100 determines whether a travel distance from the garage at home is equal to or greater than TH3 (step S36). TH3 is, for example, 88 [m]. TH3 is a distance to a range set as necessary for the second map information to be generated for manual driving.

When it is determined in step S36 that the travel distance from the home is not equal to or greater than TH3 (step S36: No), the control device 100 repeats processing of step S36. When it is determined in step S36 that the travel distance from the home is equal to or greater than TH3 (step S36: Yes), the control device 100 stores the generated second map information in the storage unit 120 (step S37).

The control device 100 starts the travel control in the first travel mode based on the first map information (step S38). At this time, the control device 100 issues a notification, for example, "MAP INFORMATION HAS BEEN STORED. GENERAL ROAD AUTONOMOUS TRAVELING WILL BE PERFORMED" by characters, a voice, an indicator, or the like via the navigation HMI 62.

Although the temporary stop position is stored as the road boundary in step S35 when the registration operation from the user is received in step S34, the present disclosure is not limited thereto. For example, when the vehicle 1 temporarily stops, the control device 100 may automatically register the temporary stop position as the road boundary without receiving the registration operation of the user.

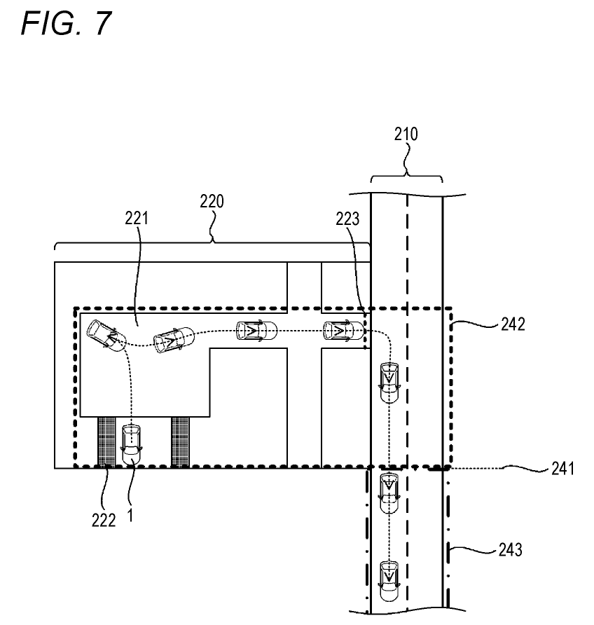

FIG. 7 is a diagram illustrating an example of a state of the vehicle 1 traveling from home to the destination during the memory processing for leaving. The user of the vehicle 1 causes the vehicle 1 to leave the garage 222 at home, travel on the private road 221 of the private land 220, enter the general road 210, and head to the destination.

First, the navigation setting for performing the memory processing for causing the vehicle 1 to leave the garage at home is performed. In FIG. 7, for example, it is assumed that the navigation setting of the memory processing for causing the vehicle 1 to leave is performed when the user gets in the vehicle 1 stopped in the garage 222 at home. When the navigation setting is performed, the vehicle 1 issues a notification, for example, "PLEASE LEAVE VEHICLE BY MANUAL DRIVING SINCE MAP INFORMATION FOR AUTONOMOUS LEAVING IS STORED", and thus the user causes the vehicle 1 to leave the garage 222 by the manual driving and to travel to the general road 210 through the private road 221. In addition, since the vehicle 1 issues a notification, for example, "PLEASE TEMPORARILY STOP BEFORE ENTERING GENERAL ROAD FROM PRIVATE ROAD AND REGISTER TEMPORARY STOP POSITION", the user performs an operation of temporarily stopping the vehicle 1 and registering the temporary stop position as a boundary point of the roads.

The vehicle 1 generates the SLAM map (second map information) in which the route information of the vehicle 1 acquired by the manual driving of the user is associated with the map information based on the external environment information. The vehicle 1 generates the SLAM map until the travel distance from the garage 222 at home is, for example, 88 [m]. In FIG. 7, a position at a distance of 88 [m] from the garage 222 is a point 241. The vehicle 1 generates the SLAM map in a section 242 (within a broken line) that is a range from when the vehicle 1 starts leaving the garage 222 by the manual driving of the user to when the vehicle 1 reaches the point 241. The section 242 includes not only the private road 221 leading to the garage 222 in the private land 220 but also a part of the general road 210 connected the private road 221.

The vehicle 1 stores the SLAM map generated in the section 242 based on the manual driving of the user in the storage unit 120. In addition, the vehicle 1 stores the temporary stop position of the vehicle 1 for which the registration operation is received from the user in the storage unit 120 as a road boundary 223.

The vehicle 1 performs the travel control in the general road travel assistance control based on the navigation map and the high-definition map on the general road 210 in a section 243 (within a one-dot chain line) after the point 241.

FIG. 8 is a diagram illustrating an example of a notification screen to be displayed during the memory processing for leaving. As shown in FIG. 8, the notification screen is displayed on the navigation HMI 62 of the navigation device 60, for example. The notification screen displays a message 251 notifying that the memory processing for leaving is started, such as "MEMORY OPERATION WILL BE PERFORMED UNTIL GENERAL ROAD AUTONOMOUS TRAVELING IS POSSIBLE". The notification screen displays a message 252 prompting the user to stop at a switching position from the private road 221 to the general road 210, such as "PLEASE TEMPORARILY STOP BEFORE ENTERING GENERAL ROAD AND PERFORM REGISTRATION OPERATION". The notification screen displays a "ROAD BOUNDARY REGISTRATION" button 253 which can be operated to register the temporary stop position as the road boundary 223.

Regeneration Processing for Leaving

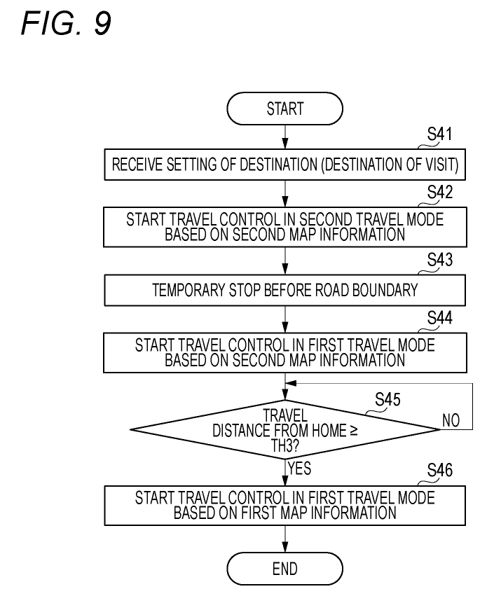

FIG. 9 is a flowchart illustrating an example of regeneration processing for causing the vehicle 1 to leave the garage 222 at home by the private road travel assistance control. The user who gets on the vehicle 1 causes the vehicle 1 to leave the garage 222 at home and is going out. However, this example is a situation in which the memory processing for leaving described in FIG. 6 to 8 is already completed, and the second map information (SLAM map) is stored in the storage unit 120. The vehicle 1 can perform the regeneration processing for causing the vehicle 1 to leave the garage 222 by the private road travel assistance control based on the second map information. The user operates, for example, the navigation HMI 62 of the navigation device 60 to perform the navigation setting in which the destination of the vehicle 1 is the destination of visit, and performs the regeneration processing for leaving.

The control device 100 receives the navigation setting from the user with the destination being the destination of visit (step S41).

The control device 100 starts the travel control in the second travel mode (private road travel assistance control) based on the second map information (SLAM map) (step S42). At this time, the control device 100 issues a notification, for example, "AUTONOMOUS LEAVING IS BEING PERFORMED" by characters, a voice, an indicator, or the like via the navigation HMI 62.

The control device 100 temporarily stops the vehicle 1 before the road boundary 223 stored as the temporary stop position when traveling from the private road 221 to the general road 210 (step S43).

When the vehicle 1 is temporarily stopped before the road boundary 223 and the vehicle 1 is caused to travel from the private road 221 to the general road 210, the control device 100 starts the travel control in the first travel mode (general road travel assistance control) based on the second map information (step S44). At this time, the control device 100 issues the notification, for example, "GENERAL ROAD AUTONOMOUS TRAVELING IS BEING PERFORMED" by the characters, the voice, the indicator, or the like via the navigation HMI 62.

Next, the control device 100 determines whether the travel distance from the garage 222 at home is equal to or greater than TH3 (step S45). TH3 is, for example, 88 [m]. When it is determined in step S45 that the travel distance from the garage 222 is not equal to or greater than TH3 (step S45: No), the control device 100 repeats processing of step S45. When it is determined in step S45 that the travel distance from the garage 222 is equal to or greater than TH3 (step S45: Yes), the control device 100 starts the travel control in the first travel mode based on the first map information (step S46).

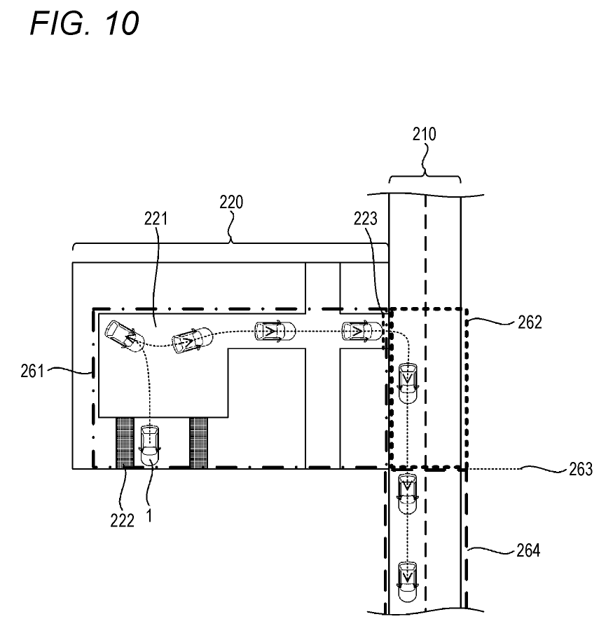

FIG. 10 is a diagram illustrating an example of a state in which the vehicle 1 travels from home to the destination during the regeneration processing for leaving. The user is leaving home and heading to the destination by the autonomous traveling of the vehicle 1. The user performs the navigation setting with the destination of the vehicle 1 being the destination of visit.

The vehicle 1 is caused to leave the garage 222 by the private road travel assistance control (second travel mode) based on the stored SLAM map (second map information), and then travel on the private road 221 to the general road 210. The vehicle 1 is temporarily stopped before the road boundary 223 stored as the stop position when traveling from the private road 221 to the general road 210. The vehicle 1 performs the travel control in the private road travel assistance control based on the SLAM map in a section 261 (within a one-dot chain line) including a region from the garage 222 to the road boundary 223.

When the vehicle 1 travels from the private road 221 to the general road 210, the travel control of the vehicle 1 transitions from the private road travel assistance control based on the SLAM map to the general road travel assistance control (first travel mode) based on the SLAM map. The vehicle 1 first travels on the general road 210 by the general road travel assistance control based on the SLAM map. Even after entering the general road 210, the vehicle 1 performs the travel control in the general road travel assistance control based on the SLAM map in a section 262 (within a broken line) until reaching a point 263 where the SLAM map is generated.

The vehicle 1 transitions the travel control of the vehicle 1 from the general road travel assistance control based on the SLAM map to the general road travel assistance control based on the navigation map and the high-definition map on the general road 210 where the SLAM map is not generated after the point 263. The vehicle 1 performs the travel control in the general road travel assistance control based on the navigation map and the high-definition map in a section 264 (within a broken line) after the point 263.

As described above, the control device 100 can perform the entering control that performs the traveling with the garage 222 at home as the destination and includes the transition from the general road travel assistance control to the private road travel assistance control, and the leaving control that performs the traveling from the garage 222 at home to the destination and includes the transition from the private road travel assistance control to the general road travel assistance control. In the entering control, the control device 100 starts the traveling by the general road travel assistance control, switches the reference map from the navigation map and the high-definition map to the SLAM map, and transitions the travel mode to the private road travel assistance control at the point 234 where the distance to the garage 222 at home is, for example, less than 10 m, and in the leaving control, the control device 100 starts the traveling by the private road travel assistance control, switches the reference map from the SLAM map to the navigation map and the high-definition map, and transitions the travel mode to the general road travel assistance control at the road boundary 223 which is the temporary stop position registered in advance. According to this configuration, by setting the point 234, which is a point where the transition from the general road travel assistance control to the private road travel assistance control is performed in the entering control that performs the traveling with the garage 222 at home as the destination, and the road boundary 223, which is a point where the transition from the private road travel assistance control to the general road travel assistance control is performed in the leaving control that performs the traveling from the garage 222 at home to the destination, at different positions, it is possible to perform the transition of the travel modes at respective appropriate positions in the entering control and the leaving control. Accordingly, the travel mode autonomously transitions at predetermined points in the entering control and the leaving control, and thus smooth and seamless travel control can be performed.

According to the control device 100, in the entering control for causing the vehicle 1 to enter the garage 222 at home, the map to be referred to is switched from the navigation map and the high-definition map to the SLAM map while traveling on the general road 210 from the destination to home by the general road travel assistance control. Accordingly, the travel mode can transition at an appropriate position in the entering control, and the travel control of the vehicle 1 can be smoothly performed.

According to the control device 100, in the leaving control for causing the vehicle 1 to leave the garage 222 at home, the vehicle 1 starts to leave the garage 222 while referring to the SLAM map by the private road travel assistance control, travels from the private road 221 of the private land 220 to the general road 210, and switches the map to be referred to from the SLAM map to the navigation map and the high-definition map while traveling on the general road 210 by the private road travel assistance control. Accordingly, the travel mode can transition at an appropriate position in the leaving control, and the travel control of the vehicle 1 can be smoothly performed.

According to the control device 100, in the leaving control for causing the vehicle 1 to leave the garage 222 at home, control accuracy of the travel control based on the SLAM map in a garage peripheral region from the garage 222 to the first point at the predetermined distance is set to be higher than control accuracy of the travel control based on the SLAM map in the private road 221 in a region away from the first point. Accordingly, the vehicle 1 can be accurately moved from the garage 222 to the first point, and the smooth travel control in the leaving control can be performed.

According to the control device 100, in the entering control for causing the vehicle 1 to enter the garage 222 at home, control accuracy of the travel control based on the SLAM map in a garage peripheral region to the second point where the distance to the garage 222 is the predetermined distance is set to be higher than control accuracy of the travel control based on the SLAM map in the private road 221 in a region away from the second point. Accordingly, the vehicle 1 can be accurately moved from the second point before the garage 222 to the garage 222, and the smooth travel control in the entering control can be performed.

The control method described in the above embodiment may be implemented by a computer executing a control program prepared in advance. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present disclosure is not limited to the above embodiment, and modifications, improvements, and the like can be appropriately made.

For example, although an example in which the moving object is a vehicle has been described in the above embodiment, the present disclosure is not limited thereto. The idea of the present disclosure is not limited to the vehicle, and may also be applied to a robot, a ship, an aircraft, or the like that includes a drive source and that can be moved by power of the drive source.

In the present description, at least the following matters are described. Although corresponding constituent elements or the like in the embodiment described above are shown in parentheses, the present disclosure is not limited thereto.

(1) A vehicle control device (control device 100) capable of transitioning between a first travel mode (general road travel assistance control) and a second travel mode (private road travel assistance control), the vehicle control device including:

one or more processors (movement control unit 130 (ADAS control unit 131, AD control unit 132, and APS control unit 133) configured to perform travel control for moving, to a target position, a vehicle (vehicle 1) including an external environment recognition unit (external environment recognition unit 110) configured to perform external environment recognition; and

a storage unit (storage unit 120) configured to store map information, in which

the map information includes first map information (navigation map, high-definition map) and second map information (SLAM map),

the first travel mode allows the vehicle to travel in a wider range than the second travel mode,

first travel control (entering control) that performs traveling with a first stop position as a target position and includes a transition from the first travel mode to the second travel mode, and second travel control (leaving control) that performs traveling from a second stop position to a target position and includes a transition from the second travel mode to the first travel mode are possible,

the first travel control is travel control that starts traveling by the first travel mode, switches a reference map from the first map information to the second map information, and transitions to the second travel mode at a point (point 234) where a distance to the first stop position is equal to or less than a predetermined distance, and the second travel control is travel control that starts traveling by the second travel mode, switches the reference map from the second map information to the first map information, and transitions to the first travel mode at a predetermined point (road boundary 223) registered in advance.

According to (1), by setting, at different positions, a transition point from the first travel mode to the second travel mode in the first travel control that performs the traveling with the first stop position as the target position and a transition point from the second travel mode to the first travel mode in the second travel control that performs the traveling from the second stop position to the target position, it is possible to perform the transition of the travel modes at the respective appropriate positions in the first travel control and the second travel control, and to perform smooth and seamless travel control.

(2) The vehicle control device according to (1), in which

the first map information includes road link information on a general road and a highway, and

the second map information includes environment information based on the external environment recognition.

According to (2), it is possible to appropriately manage and use the map information to be referred to in the first travel mode and the second travel mode.

(3) The vehicle control device according to (1) or (2), in which

in the first travel control, the reference map is switched from the first map information to the second map information during traveling on a general road.

According to (3), by referring to the second map information during traveling on the general road, the first travel control can be a smooth travel control.

(4) The vehicle control device according to any one of (1) to (3), in which

in the second travel control, the second map information is used as the reference map from the second stop position, and the reference map is switched from the second map information to the first map information during traveling on a general road.

According to (4), by referring to the second map information until traveling on the general road, the second travel control can be a smooth travel control.

(5) The vehicle control device according to any one of (1) to (4), in which

the second map information is capable of storing travel information on a general road and a private road, and

when the second map information to be used in the second travel control is generated,

a notification prompting a driver of the vehicle to stop at a switching position from the private road to the general road is issued, and

a position where the vehicle stops in response to the notification is registered as the predetermined point.

According to (5), by setting a point where the vehicle temporarily stops as a point where the travel mode of the vehicle transitions to the first travel mode, the second travel control can be a smooth travel control.

(6) The vehicle control device according to any one of (1) to (5), in which

in the second travel control, control accuracy of travel control based on the second map information from the second stop position to a first point at a predetermined distance is set to be higher than control accuracy of travel control based on the second map information from the first point.

According to (6), the vehicle can be accurately moved from the second stop position to the first point.

(7) The vehicle control device according to any one of (1) to (6), in which

in the first travel control, control accuracy of travel control based on the second map information to a second point where a distance to the first stop position is a predetermined distance is set to be higher than control accuracy of travel control based on the second map information from the second point.

According to (7), the vehicle can be accurately moved from the second point to the first stop position.

(8) A vehicle control method performed by a vehicle control device, the vehicle control device being configured to transition between a first travel mode and a second travel mode and including one or more processors configured to perform travel control for moving, to a target position, a vehicle including an external environment recognition unit configured to perform external environment recognition, and a storage unit configured to store map information, in which

the map information includes first map information and second map information,

the first travel mode allows the vehicle to travel in a wider range than the second travel mode,

the vehicle control method includes:

performing, by the vehicle control device, first travel control that performs traveling with a first stop position as a target position and includes a transition from the first travel mode to the second travel mode, and second travel control that performs traveling from a second stop position to a target position and includes a transition from the second travel mode to the first travel mode,

the first travel control is travel control that starts traveling by the first travel mode, switches a reference map from the first map information to the second map information, and transitions to the second travel mode at a point where a distance to the first stop position is equal to or less than a predetermined distance, and

the second travel control is travel control that starts traveling by the second travel mode, switches the reference map from the second map information to the first map information, and transitions to the first travel mode at a predetermined point registered in advance.

According to (8), by setting, at different positions, a transition point from the first travel mode to the second travel mode in the first travel control that performs the traveling with the first stop position as the target position and a transition point from the second travel mode to the first travel mode in the second travel control that performs the traveling from the second stop position to the target position, it is possible to perform the transition of the travel modes at the respective appropriate positions in the first travel control and the second travel control, and to perform smooth and seamless travel control.

(9) A vehicle control program for a vehicle control device, the vehicle control device being configured to transition between a first travel mode and a second travel mode and including one or more processors configured to perform travel control for moving, to a target position, a vehicle including an external environment recognition unit configured to perform external environment recognition, and a storage unit configured to store map information, in which

the map information includes first map information and second map information,

the first travel mode allows the vehicle to travel in a wider range than the second travel mode,

the vehicle control program causes the processor of the vehicle control device to perform

first travel control that performs traveling with a first stop position as a target position and includes a transition from the first travel mode to the second travel mode, and second travel control that performs traveling from a second stop position to a target position and includes a transition from the second travel mode to the first travel mode,

the first travel control is travel control that starts traveling by the first travel mode, switches a reference map from the first map information to the second map information, and transitions to the second travel mode at a point where a distance to the first stop position is equal to or less than a predetermined distance, and

the second travel control is travel control that starts traveling by the second travel mode, switches the reference map from the second map information to the first map information, and transitions to the first travel mode at a predetermined point registered in advance.

According to (9), by setting, at different positions, a transition point from the first travel mode to the second travel mode in the first travel control that performs the traveling with the first stop position as the target position and a transition point from the second travel mode to the first travel mode in the second travel control that performs the traveling from the second stop position to the target position, it is possible to perform the transition of the travel modes at the respective appropriate positions in the first travel control and the second travel control, and to perform smooth and seamless travel control.

1. A vehicle control device capable of transitioning between a first travel mode and a second travel mode, the vehicle control device comprising:
one or more processors configured to perform travel control for moving, to a target position, a vehicle including an external environment recognition unit configured to perform external environment recognition; and
a storage unit configured to store map information, wherein
the map information includes first map information and second map information,
the first travel mode allows the vehicle to travel in a wider range than the second travel mode,
the vehicle control device is capable of first travel control that performs traveling with a first stop position as a target position and that includes a transition from the first travel mode to the second travel mode, and second travel control that performs traveling from a second stop position to a target position and that includes a transition from the second travel mode to the first travel mode,
the first travel control is travel control that starts traveling by the first travel mode, switches a reference map from the first map information to the second map information, and transitions to the second travel mode at a point where a distance to the first stop position is equal to or less than a predetermined distance, and
the second travel control is travel control that starts traveling by the second travel mode, switches the reference map from the second map information to the first map information, and transitions to the first travel mode at a predetermined point registered in advance.

2. The vehicle control device according to claim 1, wherein
the first map information includes road link information on a general road and a highway, and
the second map information includes environment information based on the external environment recognition.

3. The vehicle control device according to claim 1, wherein
in the first travel control, the vehicle control device switches the reference map from the first map information to the second map information during traveling on a general road.

4. The vehicle control device according to claim 1, wherein
in the second travel control, the vehicle control device uses the second map information as the reference map from the second stop position, and switches the reference map from the second map information to the first map information during traveling on a general road.

5. The vehicle control device according to claim 1, wherein
the second map information stores travel information on a general road and a private road, and
when generating the second map information to be used in the second travel control,
the vehicle control device issues a notification prompting a driver of the vehicle to stop at a switching position from the private road to the general road, and
the vehicle control device registers a position where the vehicle stops in response to the notification as the predetermined point.

6. The vehicle control device according to claim 1, wherein
in the second travel control, the vehicle control device sets control accuracy of travel control based on the second map information from the second stop position to a first point at a predetermined distance to be higher than control accuracy of travel control based on the second map information from the first point.

7. The vehicle control device according to claim 1, wherein
in the first travel control, the vehicle control device sets control accuracy of travel control based on the second map information to a second point where a distance to the first stop position is a predetermined distance to be higher than control accuracy of travel control based on the second map information from the second point.

8. A vehicle control method performed by a vehicle control device, wherein
the vehicle control device includes one or more processors configured to perform travel control for moving, to a target position, a vehicle including an external environment recognition unit configured to perform external environment recognition, and a storage unit configured to store map information,
the vehicle control device is configured to transition between a first travel mode and a second travel mode,
the map information includes first map information and second map information,
the first travel mode allows the vehicle to travel in a wider range than the second travel mode,
the vehicle control method comprises performing first travel control that performs traveling with a first stop position as a target position and includes a transition from the first travel mode to the second travel mode, and second travel control that performs traveling from a second stop position to a target position and includes a transition from the second travel mode to the first travel mode,
the first travel control is travel control that starts traveling by the first travel mode, switches a reference map from the first map information to the second map information, and transitions to the second travel mode at a point where a distance to the first stop position is equal to or less than a predetermined distance, and
the second travel control is travel control that starts traveling by the second travel mode, switches the reference map from the second map information to the first map information, and transitions to the first travel mode at a predetermined point registered in advance.

9. A non-transitory computer-readable storage medium storing a vehicle control program for causing a vehicle control device to execute a process, wherein
the vehicle control device includes one or more processors configured to perform travel control for moving, to a target position, a vehicle including an external environment recognition unit configured to perform external environment recognition, and a storage unit configured to store map information,
the vehicle control device is configured to transition between a first travel mode and a second travel mode,
the map information includes first map information and second map information,
the first travel mode allows the vehicle to travel in a wider range than the second travel mode,
the process comprises performing first travel control that performs traveling with a first stop position as a target position and includes a transition from the first travel mode to the second travel mode, and second travel control that performs traveling from a second stop position to a target position and includes a transition from the second travel mode to the first travel mode,
the first travel control is travel control that starts traveling by the first travel mode, switches a reference map from the first map information to the second map information, and transitions to the second travel mode at a point where a distance to the first stop position is equal to or less than a predetermined distance, and
the second travel control is travel control that starts traveling by the second travel mode, switches the reference map from the second map information to the first map information, and transitions to the first travel mode at a predetermined point registered in advance.
